(19) United States
(12) Patent Application Publication
(10) Pub. No.: US 2006/0090558 A1
(43) Pub. Date: May 4, 2006

(54) Tire wear sensor

(76) Inventor: Eric J. Raskas, St. Louis, MO (US)

Correspondence Address: Polster Lieder Woodruff and Lucchesi LC, 12412 Powerscourt Drive, Suite 200, Saint Louis, MO, 63131-3615, US

(21) Appl. No.: 10/975,840

(22) Filed: Oct. 28, 2004

(51) Int. Cl. G01M 17/02

(52) U.S. Cl. 73/146

(57) ABSTRACT

A tire wear sensor for monitoring wear of a tire comprises a sensor mounted within a tread of a tire, the sensor for monitoring wear of a tire and for generating a signal indicative of a tire needing replacement and a controller for receiving the signal.

### BACKGROUND OF THE INVENTION

This invention relates generally to a tire wear sensor for a tire, and more particularly, to a tire wear sensor for monitoring the wear characteristics of the tread portion of a tire.

Wheeled vehicles have tires, such as pneumatic tires, mounted on wheels. As the tires are used, they wear down the tread portion of the tire due to the frictional engagement of the tire to a road surface. Tire treads have a limited life that is directly related to the number of miles traveled by the tire. As the tread wears down the tire is no longer able to perform its intended functions. When a tire tread is completely worn the driver may be at a greater risk of losing control of the vehicle due to the lack of appropriate friction and gripping power of the tread. The tire may also rupture presenting a further risk to the driver and the tire fragments may cause risk to other drivers. The rupture of the tire is also costly due to the loss of the casing and the inability to have the tire retread. Further, tires, particularly for large vehicles or trucks, are expensive and it is important to monitor wear conditions to be able to change the tire prior to the tire failure. In order to optimize vehicle safety, tire performance, and tire life it is important to monitor the condition of the tread of the tire. Once the tread wears down to a particular level, it is important to change the tire or to have the tire retread. To optimize tire safety and performance it would be advantageous to monitor tire wear characteristics to know when to change a tire or to know when a tire is becoming unsafe.

Various attempts have been made in the past in an effort to monitor various conditions or parameters of a tire. One such device that has been used for monitoring tire conditions have been self-powered circuits that are positioned external of the tire, such as in the valve stem. These devices are only capable of monitoring tire pressure and are incapable of monitoring tread wear. Further, these devices are easily damaged because they are outside the tire and are susceptible to collisions or weather.

Other known devices use a passive integrated circuit positioned or adhered within to an interior surface of the tire that is activated by a radio frequency transmitter that energizes the integrated circuit by inductive coupling. Additional known devices used for monitoring tire conditions include self-powered circuits adhered within an interior surface of the tire. However, one problem common to these known devices is that it is difficult to attach the devices to the inside surface of the tire. In particular, tires are subject to numerous forces such as rotational forces and impact forces. The monitoring device must have a strong enough attachment to maintain the position of the device within the tire during rotation and impact. Another problem associated with attaching a monitoring device to an interior surface of the tire is that the weight of the device interferes with the balance of the tire. A further problem of these devices is that they are not capable of monitoring the wear characteristics of a tire.

Other devices include forming a stripe line in the tire tread which when the line wears down it will disappear to indicate the tire should be changed. Some tire manufacturers also mold in a wear indicator to an outer surface of the tire. However, with both of these devices the tire must be physically monitored. Also, the molded in wear indicator may be difficult to see to determine if the tire needs to be changed.

In view of the above noted problems, it would be advantageous to be able to monitor the wear of a tire. The present invention is designed to obviate and overcome many of the disadvantages and shortcomings associated with presently available tires. In particular, the present invention is capable of monitoring the wear of a tire and indicating when a tire should be replaced. Moreover, the tire wear sensor of the present invention does not alter the tread of the tire and therefore does not affect the braking or handling of the vehicle during other modes of operation or driving of the vehicle. Further, the present invention may be used to modify existing tires. Accordingly, it is therefore desirable to provide a tire wear sensor that monitors the wear of a tire to be able to determine when a tire needs to be replaced.

### SUMMARY OF THE INVENTION

In one form of the present invention, a tire wear sensor for monitoring wear of a tire comprises a sensor mounted within a tread of a tire, the sensor for monitoring wear of a tire and for generating a signal indicative of a tire needing replacement and a controller for receiving the signal.

In another form of the present invention, a tire monitoring system for monitoring wear of each tire of a vehicle comprises a sensor mounted within a tread of each of the tires, each of the sensors for monitoring wear of its associated tire and for generating a signal indicative of whether its associated tire needs replacement and a controller for receiving the signals from each of the sensors.

In still another form of the present invention, a tire wear sensor for monitoring wear of a tire comprises a sensor embedded in a tread of a tire, the sensor for generating a signal during each revolution of a tire, and a controlling unit positioned near the tire for receiving the signal.

In light of the foregoing comments, it will be recognized that a principal object of the present invention is to provide a tire wear sensor that is capable of determining wear characteristics of a tire.

Another object of the present invention is to provide a tire wear sensor that is of simple construction and design and which can be easily employed with highly reliable results.

Another object of the present invention is to provide a tire wear sensor that is capable of generating a signal indicative of wear characteristics of a tire for transmitting the signal to a monitoring unit or device.

A further object of the present invention is to provide a tire wear sensor that can be inserted into a tread of a tire of a vehicle and used as a conventional tire.

Another object of the present invention is to provide a tire wear sensor that is constructed to withstand abuse and friction.

A still further object of the present invention is to provide a tire wear sensor that does not have a tire tread that is altered from a conventional tire.

Another object of the present invention is to provide a tire wear sensor that may be inserted into a tire or molded into a tire during the manufacturing process and the insertion process or the molding process may be performed by automated machinery.

A still further object of the present invention is to provide a tire wear sensor that is a self-contained unit that is capable of being placed within the tread of a tire during the manufacturing process.

These and other objects and advantages of the present invention will become apparent after considering the following detailed specification in conjunction with the accompanying drawings, wherein:

### BRIEF DESCRIPTION OF THE DRAWINGS

FIG. 1 is a cross-sectional view of a tire with a preferred embodiment of a tire wear sensor constructed according to the present invention being installed within the tire;

FIG. 2 is a block diagram of a tire wear sensor constructed according to the present invention;

FIG. 3 is a block diagram of a controller unit that communicates with and retrieves information from the tire wear sensor;

FIG. 4 is a block diagram of tire wear sensors installed in tires of a vehicle and a controller unit;

FIG. 5 is a perspective view of a tire wear sensor constructed according to the present invention; and

FIG. 6 is a cross-sectional view of a tire with another preferred embodiment of a tire wire sensor constructed according to the present invention installed within the tire and in proximity to a wheel well.

### DETAILED DESCRIPTION OF THE PREFERRED EMBODIMENTS

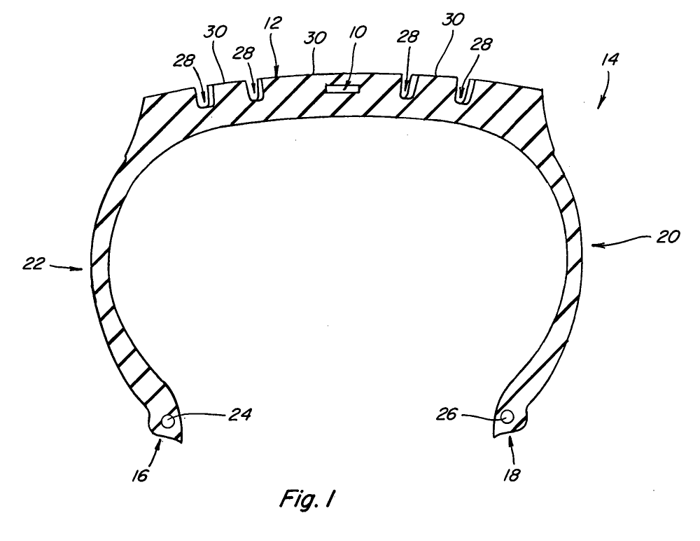

Referring now to the drawings, wherein like numbers refer to like items, number 10 identifies a preferred embodiment of a tire wear sensor constructed according to the present invention. With particular reference to FIG. 1, the tire wear sensor 10 is shown embedded within a tread portion 12 of a tire 14. The tire 14 is shown in cross-section having a pair of bead portions 16 and 18, a pair of sidewall portions 20 and 22, and the tread portion 12 toroidally extending between the sidewall portions 20 and 22. The tire 14 may also include a bead core 24 embedded in the bead portion 16 and a bead core 26 embedded in the bead portion 18. Although not shown, the tire 14 may further include other components such as a belt or belts, belt plies, plies, cords, and an air impermeable liner. The tread portion 12 may include grooves 28 and ribs 30. The grooves 28 and the ribs 30 may take on any known tread pattern or tread design. The tire wear sensor 10 is molded in place in the tread portion 12 during the manufacturing process. It is also possible that the tire wear sensor 10 may be inserted into the tread portion 12 after the tire 14 is manufactured or that the tire wear sensor 10 may be inserted into an existing tire thereby retrofitting the existing tire. The tire wear sensor 10 is positioned at a predetermined distance within the tread portion 12. When the tread portion 12 wears away the predetermined distance, the tire wear sensor 10 will indicate that the tire 14 should be replaced or retread.

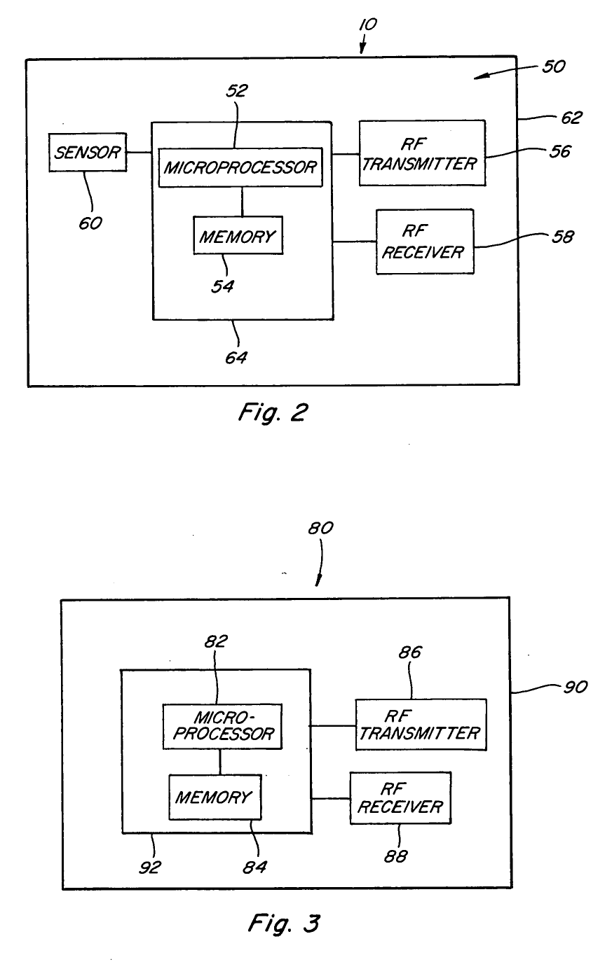

With reference now to FIG. 2, a block diagram of the tire wear sensor 10 is illustrated. The tire wear sensor 10 is shown comprising a radio frequency identification device (RFID) or tag 50. The RFID 50 includes a microprocessor 52 having a memory 54 with a radio frequency (RF) transmitter 56 and a radio frequency (RF) receiver 58 connected to the microprocessor 52. A sensor 60 is also connected to the microprocessor 52. All of these components, namely the microprocessor 52, the memory 54, the radio frequency transmitter 56, the radio frequency receiver 58, and the sensor 60 may be placed within a housing 62 to protect the device 10 when the device 10 is installed in the tread portion 12 of the tire 14. It is also possible and contemplated that the sensor 60 may extend out of the housing 62 or be completely out of the housing 62. The RFID 50 is a miniature device and may include a battery or other power source. The RFID 50 may be a passive device or an active device. The RFID 50 is capable of transmitting and receiving digital signals or messages. For example, the RFID 50 may transmit a signal that the sensor 60 has indicated that the tire 14 has worn down to such a level that the tire 14 needs to be replaced. The RFID 50 may transmit a signal that indicates the location of the tire 14 on a vehicle. For example, the tire 14 may be located at the front driver position of the vehicle and the RFID 50 would be capable of sending a signal that indicates this position. The signal may also include other information such as the make, size, and model number of the tire 14, how many times the tire 14 has been retread, and other operating conditions of the tire 14 such as maximum and minimum tire inflation information. While a radio frequency transmitter and receiver are described it should be appreciated that other known communication links may be employed such as an infrared link, a Bluetooth wireless link, or an inductive link and that other frequency ranges may be employed such as microwave frequencies.

The RFID 50 includes a circuit board 64 to have mounted thereon the microprocessor 52 and the memory 54. Further, the RF transmitter 56 and the RF receiver, as well as the sensor 60, may also be mounted on the circuit board 64. The microprocessor 52 may include analog and digital converters for digitally coding analog signals. Suitable RFID 50 devices are commercially available and are provided with an input for connecting the sensor 60 to the microprocessor 52. The microprocessor 52 has a central processing unit for processing commands, internal memory, such as RAM and ROM memory, and circuitry for transmission and reception radio frequency signals from the RF transmitter 56 and the RF receiver 58. The microprocessor 52 may also include circuitry for low and high frequency transmission or reception of signals to wake up or turn off to outside signals or instructions, as will be discussed more fully herein. The microprocessor 52 may include communication ports for supporting digital and analog inputs or outputs. Analog or digital input ports may be connected to one or more sensors 60. The microprocessor 52 may be able to execute various predefined commands or instructions sent by radio transmission and be able to transmit information or data. Some of the commands may include information concerning identification of the RFID 50, memory, reading or writing memory, password or security, and enable or disable functions or commands.

The sensor 60 may be a piezo resistive sensor or a crystal. When the tread of the tire wears down to the point that the sensor 60 is exposed to the road, the sensor 60 will be destroyed. The RFID 50 will be able to determine that the sensor 60 has been destroyed and this will be indicative of the tire needing replacement or retread. It is also possible that the destruction of the RFID 50 serves as an indication that the tire needs replacement or retread.

FIG. 3 illustrates a block diagram of a controller unit 80 that is used to control the operation of the RFID 50 of the tire wear sensor 10 and to communicate with the RFID 50. The controller unit 80 includes a microprocessor 82 having a memory 84 with a radio frequency (RF) transmitter 86 and a radio frequency (RF) receiver 88 connected to the microprocessor 82. All of the components in the controller unit 80, the microprocessor 82, the memory 84, the radio frequency transmitter 86, and the radio frequency receiver 88 may be placed within a housing 90. Further, the microprocessor 82 and the memory 84 may be positioned on a circuit board 92. Further, the RF transmitter 86 and the RF receiver 88 may also be positioned on the circuit board 92. The controller unit 80 may communicate with the RFID 50 by use of dual frequency bands so that only the RFID 50 programmed to respond to a certain band will be activated. The controller unit 80 may include input and output communications hardware to support interaction with a central computer by parallel, serial, or Ethernet links. The controller unit 80 may be interfaced with a computer to allow downloading, saving, and analysis of information received from the RFID 50. The controller unit 80 may further include other features or functions such as software for identifying, communicating, and monitoring other RFID 50 devices that may be installed in every tire on a vehicle. The broadcast range of the controller unit 80 may vary in order for the unit 80 to easily communicate with every tire on a vehicle.

The controller unit 80 can be located in a vehicle to allow for monitoring at predetermined intervals of time. For example, the unit 80 may be positioned in a hub of a wheel, in a wheel well, in an engine compartment, or in the interior of the vehicle. A driver of the vehicle may be alerted of the tire being worn down to a predetermined level that indicates that the tire should be replaced. Alternatively, the controller unit 80 may be located at a fuel station, truck terminal, or State sanctioned weigh station for monitoring all of the tires on the vehicle. In this manner a vehicle may be inspected to determine if the tires have sufficient tread to allow the vehicle to travel on a highway.

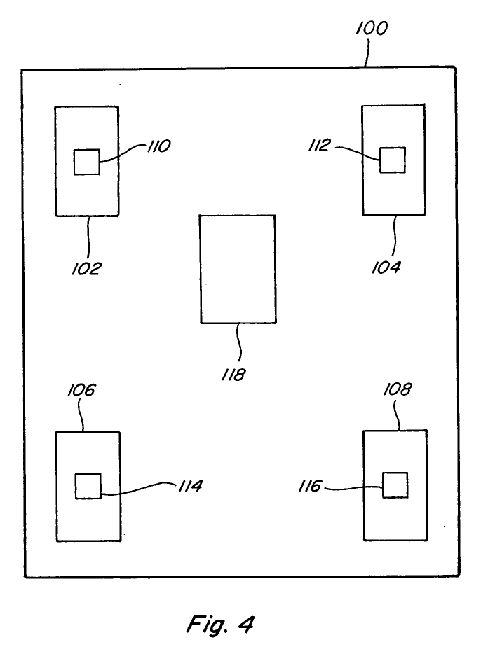

FIG. 4 depicts a wheeled vehicle 100 having four tires 102, 104, 106, and 108 installed on the vehicle 100. The tire 102, which is the left front driver side tire, has an RFID 110 installed therein. The tire 104, which is the right front passenger side tire, has an RFID 112 installed therein. The tire 106, which is the left rear driver side tire, has an RFID 114 positioned therein. Finally, the tire 108, which is the right rear passenger side tire, also has an RFID 116 placed within. The RFID's 110, 112, 114, and 116 are similar to the RFID 50. The vehicle 100 also has a controller unit 118 that is capable of communicating with the RFID's 110, 112, 114, and 116. The controller unit 118 may send out signals on a predetermined basis to interrogate each of the RFID's 110, 112, 114, and 116 to determine if a worn tire condition exists. If a signal is received from, for example, the RFID 110 that indicates that the front left driver side tire 102 has worn down, then the controller unit 118 can alert the driver of this condition. The RFID's 110, 112, 114, and 116 are capable of sending a signal to indicate or identify with which tire, 102, 104, 106, or 108 it is associated. The controller unit 118 may be connected to a light or gauge on the dashboard of the vehicle 100. Further, the controller unit 118 may be connected to a screen, such as a navigation system screen, for displaying a message that indicates that one of the tires 102, 104, 106, or 108 on the vehicle 100 needs to be replaced.

It is also possible that the controller unit 118 may be placed within the wheel well (not shown) of each of the tires 102, 104, 106, and 108, and that a central controller unit (not shown) may be connected to the four controller units 118 in the wheel wells. Further, a system may be constructed that takes advantage of the receivers used for remote keyless entry devices. In this construction, antennas can be installed in each wheel well and the keyless remote receiver may be modified to send out a signal through the wheel well antennas. The signal activates the RFID's 110, 112, 114, and 116 and which then broadcasts information or data concerning whether its associated tire 102, 104, 106, or 108 is worn down. As has been previously indicated, it is contemplated to position or locate the unit 118 in each of the wheel hubs.

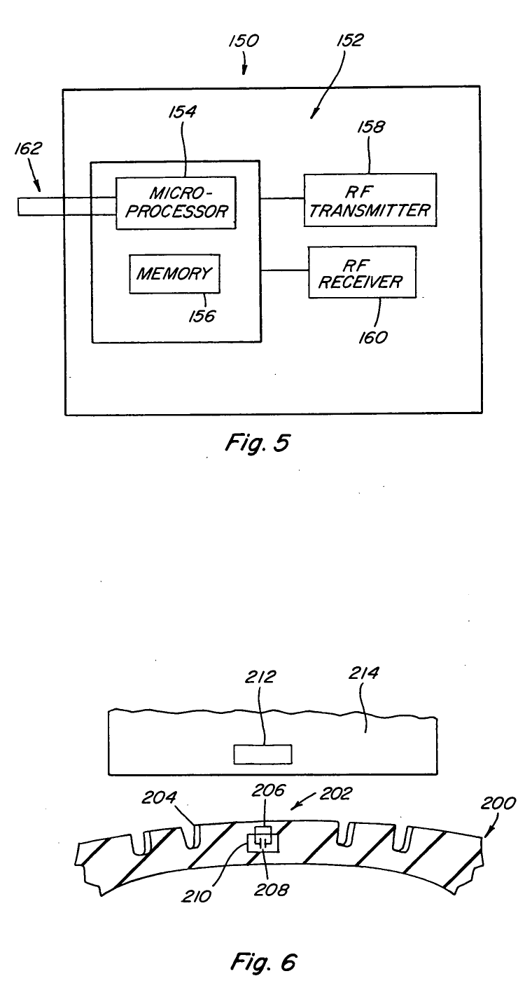

With reference now to FIG. 5, another preferred embodiment of a tire wear sensor 150 is shown. The tire wear sensor 150 comprises a radio frequency identification device (RFID) or tag 152. The RFID 152 includes a microprocessor 154 having a memory 156 with a radio frequency (RF) transmitter 158 and a radio frequency (RF) receiver 160 connected to the microprocessor 154. A sensor 162, such as a wire, is also connected to the microprocessor 154. Once the tire within which the tire wear sensor 150 is installed becomes worn to a predetermined level, the wire or sensor 162 will be exposed to the road or pavement and ultimately be destroyed by contact with the road. Once the sensor 162 is destroyed, the RFID 152 may send a signal to a controller unit, such as controller unit 80, that the tire needs to be replaced. It is also possible that the destruction of the sensor 162 terminates the ability of the RFID 152 to transmit a signal. Once the controller unit 80 is incapable of receiving a signal from the RFID 152, this is an indication that the tire needs to be replaced.

As has been previously discussed, a controller unit 80 may be located in each of the wheel wells. The sensor 162, which may act like an antenna, sends a signal to the controller unit 80 during each revolution of the tire within which the sensor is positioned. The controller unit 80 may produce a continuous waveform that indicates that the sensor 162 is functioning. Once the sensor 162 is destroyed no signal will be picked up by the controller unit 80 that indicates that the tire needs to be replaced or serviced.

FIG. 6 depicts a cross-sectional view of a tire 200 having another preferred embodiment of a tire wear sensor 202 embedded in a tread 204 of the tire 200. The tire wear sensor 202 comprises a wire 206 connected to a capacitor 208. The capacitor 208 may be located within a housing 210. A controller unit 212 is positioned within a wheel well 214 and in close proximity to the sensor 202. As the tire 200 rotates the sensor 202 passes the controller unit 212 and the controller unit 212 is capable of determining whether the sensor 202 is still functioning. The capacitor 208 functions as an amplifier. Once the tire 200 wears down to a predetermined level, the wire 206 will be exposed to the road or pavement and ultimately be destroyed by contact with the road. Once the wire 206 is destroyed the controller unit 212 will not be able to receive or pick up a signal from the sensor 202. The controller unit 212 may be connected to another unit or device (not shown) that will alert a driver that the tire 200 needs to be serviced. The controller unit 212 is also capable of sending information related to the location of which tire on a vehicle that needs to be serviced. The wire 206 and the capacitor 208 may also be connected to a radio frequency identification device.

From all that has been said, it will be clear that there has thus been shown and described herein a tire wear sensor which fulfills the various objects and advantages sought therefor. It will become apparent to those skilled in the art, however, that many changes, modifications, variations, and other uses and applications of the subject tire wear sensor is possible and contemplated. All changes, modifications, variations, and other uses and applications which do not depart from the spirit and scope of the invention are deemed to be covered by the invention, which is limited only by the claims which follow.

What is claimed is:

1. A tire wear sensor for monitoring wear of a tire comprises a sensor mounted within a tread of a tire, the sensor for monitoring wear of a tire and for generating a signal indicative of a tire needing replacement and a controller for receiving the signal.

2. The tire wear sensor of claim 1 wherein the sensor is positioned within the tread at a predetermined level.

3. The tire wear sensor of claim 1 wherein the sensor comprises a wire that is destroyed once the tread wears to a predetermined level.

4. The tire wear sensor of claim 1 wherein the sensor comprises a radio frequency identification device.

5. The tire wear sensor of claim 4 wherein the radio frequency identification device comprises a microprocessor capable of transmitting the signal indicative of a tire needing replacement.

6. The tire wear sensor of claim 5 wherein the radio frequency identification device further comprises a radio frequency transmitter.

7. The tire wear sensor of claim 1 wherein the controller comprises a microprocessor capable of receiving the signal indicative of a tire needing replacement.

8. A tire monitoring system for monitoring wear of each tire of a vehicle comprising a sensor mounted within a tread of each of the tires, each of the sensors for monitoring wear of its associated tire and for generating a signal indicative of whether its associated tire needs replacement and a controller for receiving the signals from each of the sensors.

9. The tire monitoring system of claim 8 wherein each of the sensors is positioned within the tread of its associated tire at a predetermined level.

10. The tire monitoring system of claim 8 wherein each of the sensors comprises a wire that is destroyed once the tread of its associated tire wears to a predetermined level.

11. The tire monitoring system of claim 8 wherein each of the sensors comprises a radio frequency identification device.

12. The tire monitoring system of claim 11 wherein each of the radio frequency identification devices comprises a microprocessor capable of transmitting the signal indicative of a tire needing replacement.

13. The tire monitoring system of claim 12 wherein each of the radio frequency identification devices further comprises a radio frequency transmitter.

14. The tire monitoring device of claim 8 wherein the controller comprises a microprocessor capable of receiving the signals indicative of a tire needing replacement.

15. The tire monitoring device of claim 8 wherein the controller comprises an antenna associated with each of the tires with the antenna is capable of receiving the signals indicative of a tire needing replacement.

16. A tire wear sensor for monitoring wear of a tire comprises a sensor embedded in a tread of a tire, the sensor for generating a signal during each revolution of a tire, and a controlling unit positioned near the tire for receiving the signal.

17. The tire wear sensor of claim 16 wherein the sensor comprises a wire that is destroyed once the tread wears to a predetermined level.

18. The tire wear sensor of claim 16 wherein the sensor comprises a radio frequency identification device.

19. The tire wear sensor of claim 18 wherein the radio frequency identification device comprises a microprocessor capable of transmitting the signal.

20. The tire wear sensor of claim 16 wherein the controller comprises a microprocessor capable of receiving the signal from the sensor.
